(19) United States
(12) Patent Application Publication
(10) Pub. No.: US 2006/0289178 A1
(43) Pub. Date: Dec. 28, 2006

(54) Weed puller

(76) Inventor: Charles Basek, Oakville (CA)

Correspondence Address: BERESKIN AND PARR, 40 KING STREET WEST, BOX 401, TORONTO, ON, M5H 3Y2, CA

(21) Appl. No.: 11/431,821

(22) Filed: May 11, 2006

Related U.S. Application Data
(60) Provisional application No. 60/679,973, filed on May 12, 2005.

(30) Foreign Application Priority Data
May 12, 2005 (CA) 2,507,157

(51) Int. Cl. A01B 1/00

(52) U.S. Cl. 172/371

(57) ABSTRACT

An apparatus for pulling weeds has a body and a reciprocating element able to move upwards or downwards relative to the body. A first blade is attached to or integral with the lower end of the body. A retainer attached to the body holds an intermediate portion of a second blade relative to the body, but allows the second blade to pivot between open and closed positions. When the reciprocating element is in a lower position, the second blade is held in, or allowed to pivot to, its open position. When the reciprocating element is in an upper position, the second blade is held in the closed position by the reciprocating element. The reciprocating element may be biased towards the upper position. The rotating blade, when in the open position, may prevent the reciprocating element from moving to the upper position.

This is an application claiming the benefit under 35 USC 119(e) to U.S. Provisional Application No. 60/679,973 filed May 12, 2005. This application also claims priority to Canadian Application Serial No. CA 2,507,157 filed May 12, 2005. Application Ser. Nos. 60/679,973 and CA 2,507,157 are incorporated herein, in their entirety, by this reference to them.

### FIELD OF THE INVENTION

This invention relates to lawn and garden tools, and more particularly to a manually operated tool for pulling plants such as weeds out of soil.

### BACKGROUND OF THE INVENTION

The following description of the background of the invention is not an admission that anything discussed below is citable as prior art or part of the knowledge of a person skilled in the art in any country.

Weed pullers, alternately called diggers, weeders, extractors, pickers, removers or other related names, may be used to help a person remove weeds from the ground. A weed puller may be manually operated but provide a means for pulling weeds that is easier or more precise than using a simple shovel or pick. Although a weed puller is useful for pulling weeds, a weed puller is useful generally for removing plants of various kinds from soil and the description of the invention as a weed puller does not limit the invention to use for pulling weeds alone.

For example, U.S. Pat. No. 4,473,248 describes a device for extracting or pulling weeds from the ground. The device comprises an elongated stem including an inner shaft located within a hollow outer shaft, an operating means at the upper end of the stem and a pair of cooperating opposed scooping blades at the lower end of the stem. Each of the upper portions of the blades is pivotally connected via a linkage mechanism to the inner shaft and each of the center portions of the blades is pivotally connected to the outer shaft. Spring means maintains, in cooperation with the inner shaft, the lower portions of the blades in a spaced apart open position. In order to grip a root, the blades are brought into closed position by effecting via the operating means movement of the inner shaft relative to the outer shaft against the biasing force of the spring. A weed puller such as this has various attributes that make it undesirable to use or manufacture. For example, the weed puller of US '248 has an excess of various pins, hinges, levers and arms. This weed puller also relies on the strength of a user's hand to close, and keep closed, a pair of blades against the resistance of the soil and a biasing spring.

### SUMMARY OF THE INVENTION

It is an object of the invention to improve on, or at least provide a useful alternative to, prior art weed pullers. An alternative object of this invention is to provide a weed puller or a process for using a weed puller. The following summary is intended to introduce the reader to the invention but not to define the invention. The invention may reside in a combination or sub-combination of apparatus elements or process steps found in this summary or in other parts of this document, for example the claims.

In one aspect, the invention provides a weed puller comprising a body having an upper end and a lower end and a reciprocating element able to move upwards or downwards relative to the ends of the body. A first blade is attached to or integral with the lower end of the body. A retainer attached to the body holds the intermediate portion of the second blade at a point, or within a longitudinal and lateral range of distances, relative to the body, but allows the second blade to pivot between open and closed positions relative to the first blade. When the reciprocating element is in a lower position, the second blade is held in, or allowed to pivot to, its open position. When the reciprocating element is in an upper position, the reciprocating element prevents an upper portion of the second blade from moving laterally towards the body and so holds the second blade in a closed position.

In another aspect, the invention provides a weed puller comprising a body having an upper end and a lower end. A first blade and a rotating blade are attached to the lower end of the body. The rotating blade may rotate between open and closed positions relative to the first blade and is biased towards the open position. A reciprocating element may move between lower and upper positions along the body and is biased towards the upper position. The reciprocating element, when in the upper position, prevents the rotating blade from moving from the closed position to the open position. The reciprocating element, when in the lower position, occupies a portion of the space between the lower ends of the blades. The rotating blade, when in the open position, prevents the reciprocating element from moving to the upper position.

In another aspect, the invention provides a process for using a weed puller, for example a weed puller as described above. In another aspect, the invention provides a weed puller having any possible combination of any two or more of the elements described in any part of this document.

### BRIEF DESCRIPTION OF THE DRAWINGS

An embodiment or embodiments of the invention will be described below with reference to the following figures:

FIG. 1 is an isometric view of a weed puller.

FIG. 2 is an exploded view of an upper end of the weed puller of FIG. 1.

FIGS. 3, 4, and 5 are cross-sections of a lower portion of the weed puller of FIG. 1 in first, second and third positions respectively.

FIG. 6 is an isometric view of a lower portion of the weed puller of FIG. 1 viewed from below.

### DETAILED DESCRIPTION OF EMBODIMENTS

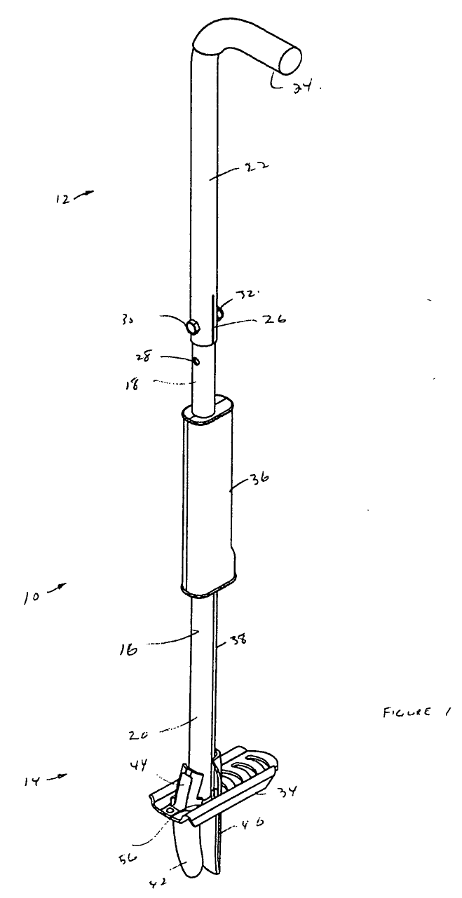

Referring primarily to FIG. 1, a weed puller 10 is shown with an upper part 12 towards the top of the figure and a lower part 14 towards the bottom of the figure. When oriented as in FIG. 1, the top of the weed puller 10 may be roughly mid thigh to chest high to a person standing next to the weed puller 10, for example with the top of the weed puller 10 at about waist height. While being inserted into the soil or pulling a weed from the soil, the weed puller may be oriented roughly vertically as shown in FIG. 1 or at some angle, for example up to about 45 degrees, from vertical that keeps the upper part 12 above the lower part 14. In the absence of any contrary indication, the words up, upper, top, proximal or other similar words may be used interchangeably to indicate elements, parts of elements, movements of elements or positions of elements closer to the top of the weed puller 10 as shown in FIG. 1 while the words down, lower, bottom, distal or other similar words may be used interchangeably to indicate elements, parts of elements, movements of elements or positions of elements closer to the bottom of the weed puller 10 as shown in FIG. 1. In the absence of any contrary indication, the words lateral, oblique, side or other similar words will refer to elements, parts of elements, positions of elements or movements of elements to the left or right of the weed puller 10 as shown in FIG. 1.

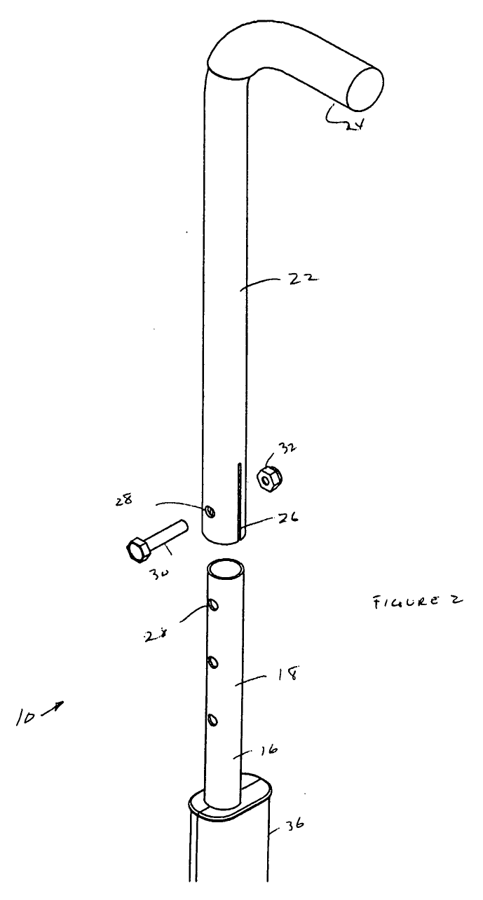

Referring to FIGS. 1 and 2, the weed puller 10 has a body 16 having a first end 18 and a second end 20. The body 16 may be elongated or shaft-like. The body may also have a constant cross-section, along some, most or all of its length and may be hollow or solid, for example a hollow cylindrical steel tube as shown. A handle 12 is attached to body 16, for example in a fixed, or temporarily fixed, position to the first end 18 of the elongated body 16. The handle 22 has a grip 24 made of a soft plastic molding slipped over an upper portion of the handle 22. While the handle 22 might optionally have a T, D or other shape, a handle 22 as shown, having a bent upper portion extending laterally in one direction from the weed puller 10, provides good rotational and positional control, particularly in combination with an actuator 36 described below, and is easy to make and compact to store or ship. A lower part of the handle 22 is hollow and sized to slip over the first end 18 of the elongated body 16 and has a hole 28 sized to receive a bolt 30 which may be secured by a nut 32. The first part 18 of the body 16 has a corresponding hole 28 such that the handle 22 may be bolted to the body 16 as shown in FIG. 1 or removed, for example for storage or packaging, as shown in FIG. 2. The handle 22 may be installed with the grip 24 in either the orientation shown in FIGS. 1 and 2 or rotated 180 degrees, to suit left or right handed users or a user's preference. Optionally, one or more additional holes 28 may be drilled at right or other angles to the hole 28 in the handle 22 or the body 16 to allow additional rotational positions of the handle 22. However, having the grip 24 located at roughly right angles, for example between 60 degrees and 120 degrees, to a step 34, to be described below, appears to provide for easy use of the weed puller 10 while allowing a person a good view of the lower part 14 of the weed puller 10 and the plant to be dug. A slit 26 is cut into the handle 22 to improve the connection between the handle 22 and the body 16 and to ease the assembly or disassembly of those components. The body 16 has multiple holes 28 at different positions along their lengths to allow the distance between the grip 24 and the rest of the digger 20 to vary. Other constructions or locations of the handle 22 or connections between the handle 22 and body 16 may also be used. For example, the handle 22 may be made integral with the body 16 by providing a grip 24 or bent section, or both, directly on the first end 18 of the body 16.

Referring primarily to FIGS. 1 and 3-5, the weed puller 10 has an actuator 36 connected to a reciprocating element 38. The actuator 36 is optional but provides a comfortable means by which the user may move the reciprocating element 38 up or down the body 16. The actuator 36 may also function as a second handle. In particular, when the reciprocating element 38 is restrained against moving either upwards or downwards, the actuator may be used to assist in lifting or lowering the weed puller 10 respectively. The actuator 36 may be used to move the body 16 sideways or sideways movement of the body 16 which, in combination with the handle 22, makes it easy for a user to pivot, rotate or position the weed puller 10. This usefulness is enhanced by locating the actuator 36 and grip 24 of the handle 22 a distance apart, for example 20 to 50 cm apart or 30 to 40 cm apart, to provide a useful lever arm between the grip 24 and actuator 36. Use of the actuator 36 as a handle is also enhanced by its location near the center of gravity of the weed puller 10, for example within 20% of the length of the weed puller 10 from the center of gravity, particularly with the handle 22 conversely located near the top of the weed puller 10.

The actuator 36 shown is a plastic molding formed in two halves screwed together about the body 16 although other constructions may be used. The actuator 36 surrounds a tip 58 of the reciprocating element 38, a pin 60 and an actuator biasing spring 62. A lower portion of the actuator 36 holds the tip 58 of the reciprocating element 38 such that the actuator 36 and reciprocating element 38 move together. The actuator 36 is prevented from rotating about the body 16 by the pin 60 which passes through a bore 64 in the body 16. The actuator 36 in turn prevents the reciprocating element 38 from rotating about the body 16 through the tip 58, optionally in conjunction with other guides, such as provided by holes in the step 34 or surfaces of the blades 40, 42. The pin 60 also bears against the sides of one or more channels 66 in the actuator 36. This prevents rotation of the actuator 36 about the body 16 as described above while still allowing the actuator 36 to reciprocate up and down the body 16 within a range. The ends of one or more of the channels 66, bearing against the pin 60, may provide stops defining the upward extent of an upper position or the downward extend of a downward position or the reciprocating element 38. Alternately or additionally, the upward extent of the reciprocating element 38 may be defined by interference between a fifth abutment 53 of the reciprocating element 38 and the step 34 or bottom of the body 16. Further alternately or additionally, the lower extent of the downward position may be defined by interference between a third abutment 50 of the reciprocating element 38 and the second blade 42 when the second blade 42 is fully open. The actuator biasing spring 62 bears against the top of the actuator 36 and the pin 60 to bias the actuator 36 upwards. This biasing is optional or may alternately be provided by another resilient means or a resilient means bearing directly on the reciprocating element 38.

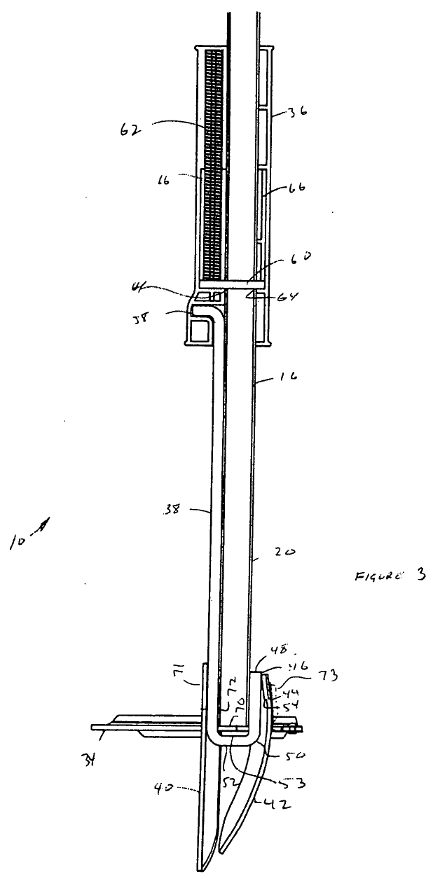

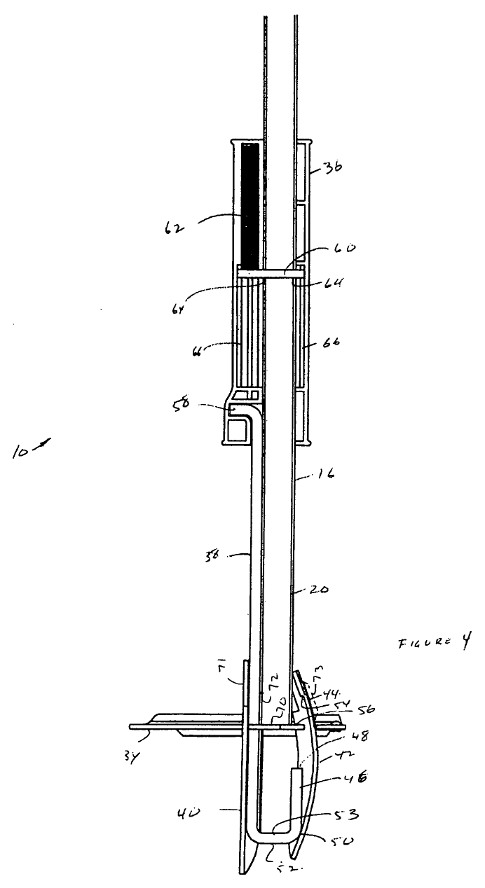

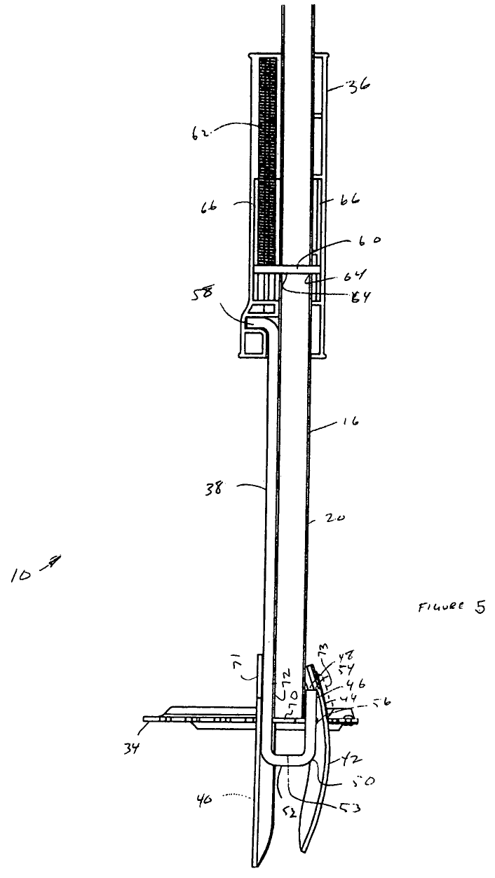

The reciprocating element 38 may be made by bending a metal rod into a shape as shown, or by other suitable methods. The shape of the reciprocating element 38 includes a first abutment 46, a second abutment 48, a third abutment 50, a fourth abutment 52 and a fifth abutment 53. As shown in FIG. 3, the first abutment 46 may contact an upper part of a second blade 46 and so prevent opening of the second blade 42 from a closed position. As shown in FIG. 5, the second abutment 48 may contact a notch 54 in the upper part of the second blade 42 to prevent the reciprocating element 38 from moving upwards past the notch 54. As shown in FIG. 4, the third abutment 50 may press against a lower end of the second blade 42 to open it or hold it open. Also as shown in FIG. 4, the fourth abutment 52 may press against any object, such as soil or part of a weed, between the blades 40, 42. As shown in FIG. 3, a fifth abutment 53 may press against the body 16 to prevent upward movement of the reciprocating element 38. The use of these abutments 46, 48, 50, 52, 53 and reciprocating element 38 will be described in detail further below after a discussion of the other parts of the weed puller 10 that the reciprocating element 38 acts on.

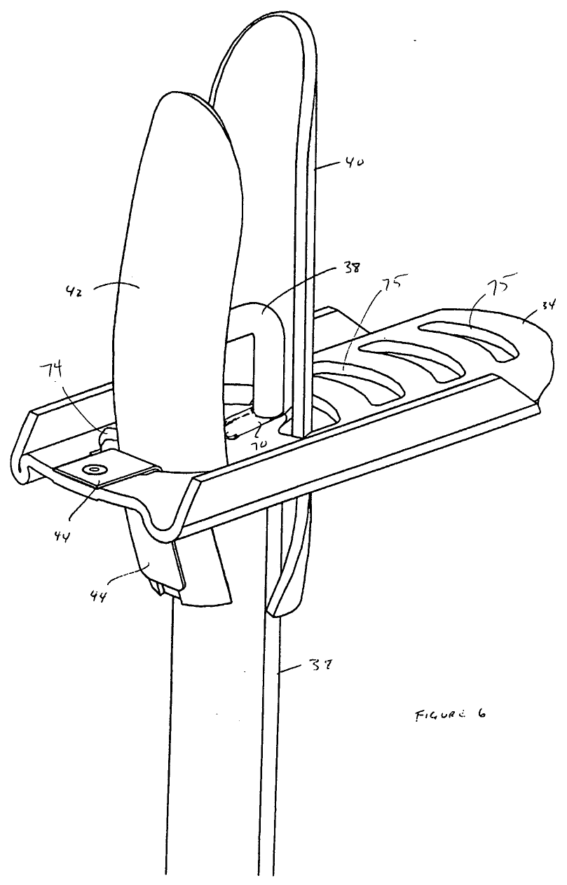

Referring primarily to FIGS. 1 and 6, movement and positioning of the weed puller 10 is also facilitated by a step 34 attached to the second end 20 of the body 16. The step 34 may also be called a plate, footpad, pedal or other similar terms and provides a place for a user to apply their foot to the weed puller 10 to assist in driving part the bottom of the weed puller 10 into soil. The step 34 shown is made of a bent and cut sheet of steel and welded to the bottom of the body 16, but other constructions or shapes may be used. The step 34 may be located in various positions on the lower part body 14 of the weed puller 10, but a step 34 located at or near, for example within 5 cm of, the bottom of the body 16, appears to allow improved control of the weed puller 10 and more comfortable use of the leg muscles than a step located further up on the body 16. It also appears helpful to have the step 34 extend roughly at right angles to the face of the blades 40, 42, to be described below, since this position removes the step 34 from a user's line of sight to a plant to be pulled located between the blades 40, 42. Locating the step 34 at an intermediate elevation relative to one or both of the blades 40, 42 also allows the step 34 to provide other functions, for example as a retainer that assists in holding a blade, 40, 42 or other parts of the weed puller 10. The step 34 may also help guide the reciprocating element 38.

Contact with a plant or soil occurs primarily through a first blade 40 and a second blade 42 on the lower part 14 of the weed puller 10. The blades 40, 42 may also be called jaws, tines, spades or other similar words. The blades 40, 42 serve to penetrate the soil around the root of a weed, to grasp the root directly or through soil haled between the blades 40, 42, to hold onto the root of the weed, directly or indirectly while the weed is pulled from the ground and to release the weed once the weed is out of the ground. One or both of the blades 40, 42 may also serve other related functions such as helping to guide the path of the weed puller 10 into the soil, slicing the soil or root, or cutting a plug of soil which may contain the root if the user chooses to rotate the weed puller 10 before removing the weed puller 10 from the soil.

The first blade 40 may be fixed to the body 16 directly or through the step 34 or other fixed components, for example by welding at one or more points of contact with the first blade 40. Optionally, the first blade 40 may be made to move like the second blade 42 but this is not necessary for the effective operation of the weed puller 10 and adds to its cost. A fixed first blade 40 also assists in operating the weed puller 10 by guiding the path of the weed puller 10 into the soil or allowing a user to predict the path of the weed puller 10 into the soil. The first blade 40 may be formed by bending a flat or arched section of metal or by other appropriate methods. A lower end of the first blade 40 may be pointed to aid in penetrating the soil. The lower end of the first blade 40 may also be made straight along its length to enhance its functions of guiding the weed puller 10 into the soil or helping a user aim the weed puller 10. An upper end of the first blade 40 may extend above the step 40 to guard the reciprocating element 38 from contact with a user's foot or a separate guard may be used.

The second blade 42 has a slot 56 which cooperates with the step 34, acting as a retainer, to prevent the second blade 42 from moving up or down in relation to the body 16 outside of a small range of movement. However, the slot 56 is wider than the thickness of the step 34 such that the second blade 42 may pivot or rotate about an axis perpendicular to the length of the body 16 between open and closed positions of the second blade 42 shown in FIGS. 5 and 4 respectively. The second blade 42 may optionally be attached to the body 16 directly or indirectly through a bolt, pin or other pivot, but the slot 56 avoids the need for these components. The second blade 42 passes through an opening in the step 34 and is restrained from moving laterally away from the body by the step 34 indirectly through a blade biasing spring 44. The second blade 42 is restrained from moving laterally towards the body 16 in various positions by one or more of the step 34, the body 16, the reciprocating element 38, the first blade 40, or soil or a plant between the blades 40, 42. The blade biasing spring 44 biases the second blade 42 towards the open position. This biasing is optional but useful because it helps keep the notch 54 in the path of the second abutment 48 of the reciprocating element 38 when desired despite movement of the weed puller 10 and avoid the need for the user to hold the second blade 42 open before inserting the blades 40,42 into the soil. Other means for biasing the second blades 42, such as coil springs, elastic bands or other suitable parts may also be used.

The second blade 42 has a lower end which angles downwardly towards the first blade 40. This angling causes the bottom of the second blade 42 to move towards the first blade 40 as the blades 40, 42 are inserted into soil avoiding the need for any other mechanism or feature to accomplish this task.

In general terms, a person uses the weed puller 10 by moving or cycling the weed puller 10 through some or all of the positions show in FIGS. 3, 4 and 5. In FIG. 5, the weed puller 10 is in an intermediate position, alternately called a ready position, with the second blade 42 in an open position, the reciprocating element 38 in an intermediate position and the blades 40, 42 out of the soil. The second blade 42 is help open by one or more of the blade biasing spring 44, or gravity or the soil acting on the lower part of the second blade 42. The reciprocating element 38 is held in the intermediate position by the actuator biasing spring 62 or by the user pulling upwards on the actuator 36. The user applies a force to one or more of the handle 22, the actuator 36 or the step 34 to locate the blades 40, 42 in an open position on the surface of the soil on either side of a weed and aimed at the root of the weed a distance, for example 4 to 10 cm, below the surface of the soil.

After positioning the weed puller 10, the user applies pressure to one or both of the handle 22 or step 34 to drive the blades 40, 42 into the soil. The pressure of the soil on the second blade 42 as the second blade 42 moves into the soil, either because of the angled portion of the bottom of the second blade 42, the path of the weed puller 10 through the soil directed by the user, or both, causes the second blade 42 to pivot to or past its closed position. Once the second blade 42 has rotated at least to the closed position, the handle biasing spring 62 or the user push the reciprocating element 38 upwards to its upper position. In this way, the weed puller 10 is configured into a first position, alternately called a closed or locked position, as shown in FIG. 3. It is not necessary for the second blade 42 to contact the first blade 40 when the weed puller 10 is in the closed or locked position. The closed or locked position may be achieved when the second blade 42 has moved enough to allow the reciprocating elements 38 to move upwards such that the first abutment 46 may contact an upper part of the second blade 42 as shown in FIG. 3. In this position, the lower part of the second blade 42 is close enough to the first blade 40 such that the root of the weed will be pinched or held, either directly or though compressed soil, between the blades 40, 42. The user may insert the weeder 10, intentionally or unintentionally, such that the second blade 42 moves past the closed position or touches the first blade. The root may also have been cut by either blade 40, 42. Optionally, the weed puller 10 may be rotated about the length of the body 16, for example by between about 10 to 90 degrees, while the blades 40, 42 are in the soil by applying pressure to one or more of the step 34, actuator 36 or handle 22 to shear or cut a plug of soil between the blades 40, 42 free from the surrounding soil. The user pulls upwards on the weed puller 10 by applying force to one or more of the actuator 36, step 34 or handle 22 to removed the weed held between the blades 40, 42 from the soil. The upper part of the second blade 42 pushes against the first abutment 46 of the reciprocating element 38 while the weed puller 10 is removed from the soil which keeps the second blade 42 from opening past the closed position and so causes the weed to be removed from the soil with the weed puller 10.

After the weed is removed from the soil, a user can move the weed puller 10 into a second position, alternately called an ejected position, as shown in FIG. 4. To achieve this position, the user pushes downwards on the actuator 38 to move the reciprocating element 38 to a lower position. In its lower position, the reciprocating element 38 no longer prevents the second blade 42 from opening. The second blade 42 may therefore open as a result of one or more of the blade biasing spring 44 pushing it open, the reciprocating element 38 or a root or soil below the reciprocating element 38 pushing the second blade 42 open, a user or gravity pulling a root or soil out from between the blades, or gravity pulling downwards on the lower part of the second blade 42. With the second blade 42 open, the root may drop free of the weed puller 10 or be pulled out of the root puller 10. However, the user may also find it useful to move the actuator 36 downwards through a long, for example 4 to 12 cm, stroke as shown in FIG. 4 to push the weed from the weed puller 10. If the actuator 36 is moved slowly, the weed will simply drop to the ground below the blades 40, 42. The user may position the blades 40, 42 over a desired place within a radius related to the length of the weed puller 10 and the user's arms before releasing the weed to simplify picking up multiple weeds pulled over an area. If the actuator 36 is moved quickly, the weed can be ejected from the weed puller 10 with some speed. If desired, the user may first aim the weed puller 10 at or above a desired point, for example the inside of a wheel barrow, and shoot the weed through the air to simplify picking up multiple weeds pulled from a larger area.

After the weed has been ejected, the user may reconfigure the weed puller 10 back into the intermediate position of FIG. 5. In the embodiment shown, the actuator biasing spring 62 and blade biasing spring 44 urge the weed puller 10 into the intermediate position automatically to ready the weed puller 10 to pull another weed.

Various features of the weed puller 10 assist in the operations described above. For example, the first abutment 46 may be generally parallel with the length of the shaft. In this way, forces created by withdrawing the digger 1 from soil do not tend to move the reciprocating element 38. Further, the exact up or down position of the reciprocating element 38 in the first position is not critical within a range. The second abutment 48 may be generally perpendicular to the length of the body 16. In this way, pressure created by the biasing of the reciprocating element 38 in the intermediate position against the notch 54 provides only a small amount of friction inhibiting rotation of the second blade 42. This small amount of friction helps keep the weed puller 10 in an intermediate position when desired but is easily overcome by earth pressure when the blades 40, 42 are inserted into soil. In the intermediate position, contact between the upper part of the second blade 42 and the body 16 prevents excessive opening of the second blade 42, for example opening such that the lower end of the second blade 42 no longer angles downwardly towards the first blade 40.

Referring primarily to FIGS. 3-5, blade biasing spring 44 may be replaced with an optional biasing spring 73 which contacts second blade 42 at two discrete points. One point is near the step 34. The other point is the end of second blade 42. Referring primarily to FIG. 6, an opening 74 in step 34 is shaped such that second blade 42 can be inserted through the part of opening 74 furthest from the body 16. However, the opening 74 narrows towards the body 16 such that, when biasing spring 44 is in place, a portion of the step 34 is located within slot 56 of the second blade 42 so as to prevent excess movement of the second blade 42 up or down relative to the body 16. Referring primarily to FIGS. 3-6, a first access slot 70 in the step 34, a second access slot 71 in the first blade 40 and a third access slot 72 in the body 16 allow the reciprocating element 38 to be mounted on the body 16 even if the step 34 and first blade 40 have already been welded to the body 16. In particular, the tip 58 and upper part of reciprocating element 38 can be inserted or removed through slots 70, 71, 72. Openings 75 in step 34 allow a user to see through step 34 when positioning the weed puller 10 over a weed.

The embodiment or embodiments described above are merely examples of the invention and the invention is not limited to the embodiments or to particular parts or features of them. The invention may be practiced in various modified forms or processes. The invention may also have less elements or steps than any embodiment described above. For example, while the availability of the three positions of FIGS. 3, 4 and 5 and the biasing springs 44, 62 make the weed puller 10 easy to use, simpler versions of the invention are also useful. For example, it is possible to dispense with either the intermediate position of FIG. 5 or the lower position of FIG. 4 or to merge those positions into one position that at least allows the second blade 42 to open. Similarly, the functions of the biasing springs 44, 62 can also be omitted since the user can achieve the same movements by manipulating other parts of the weed puller 10, particularly if the second blade 42 is mounted and shaped in such a way, for example as shown, so that it tends to open in many orientations on the weed puller 10. The notch 54 may also be removed from the second blade 42 if other means or method are provided for keeping the reciprocating element 38 from closing the second blade 42 after a weed has been pulled out from between the blades 40, 42 but before the weed puller 10 is reinserted into the soil. For example, the user may simply hold the actuator 38 in a suitable position manually or the actuator biasing spring 62 may be shorted or moved such that it does not push the reciprocating element 38 all the way to the upper position. Alternately the invention may have more elements or steps than as described for the embodiments. For example, the step 34 might fold, the first blade 40 might pivot or rotate as does the second blade 42, and various catches, levers triggers or biasing means may be added. Changes for manufacturing, shipping, packaging or storage preference or to adapt the device to different materials may also be made. Peripheral features such as a basket or bag holder on the body or an element to assist in hanging the weed puller 10 on a wall or other place may also be added.

I claim:

1. An apparatus for removing plants from soil comprising,
a) an body having a first end and a second end;
b) a reciprocating element connected to the body so as to be able to move upwards and downwards relative to the first and second ends of the elongate body;
c) a first blade attached to or integral with the second end of the body and having a distal end relative to the first end of the body;
d) a second blade having a distal, intermediate and proximal portions relative to the first end of the body; and,
e) a retainer attached to the body and holding the intermediate portion of the second blade at a point or within a longitudinal and lateral range of distances relative to the elongate body, wherein,
f) the apparatus is configurable in and movable between a first position and a second position,
g) in the first position, the proximal portion of the second blade is prevented from moving laterally towards the body by the reciprocating element, the intermediate portion of the second blade is prevented from moving laterally away from the body and the distal portion of the second blade is adjacent or near the distal end of the first blade,
h) in the second position, the distal portion of the second blade is further laterally from the distal end of the first blade than in the first position and the reciprocating element is further towards the second end of the body than in the first position.

2. The apparatus of claim 1 further comprising a first handle attached to or integrated with the body in a fixed position.

3. The apparatus of claim 1 wherein the reciprocating element is made of a unitary construction such as being bent from a rod or tube.

4. The apparatus of claim 1 having a guide, holder, pin or other means to prevent or inhibit rotation of the reciprocating element about the body.

5. The apparatus of claim 1 having a second handle attached to or integral with a part of the reciprocating element.

6. The apparatus of claim 1 having a second handle slideable on the body.

7. The apparatus of claim 5 wherein the second handle is biased towards the top of the body.

8. The apparatus of claim 6 wherein the second handle has an internal resilient element.

9. The apparatus of claim 1 having a stop to prevent movement of the reciprocating element downwards past a lower position.

10. The apparatus of claim 1 having a stop to prevent movement of the reciprocating element upwards past an upper position.

11. The apparatus of claim 1 having a stop to temporarily prevent the reciprocating element from moving upwards past an intermediate position.

12. The apparatus of claim 1 having a stop to restrict or prevent rotation of the reciprocating element about the shaft.

13. The apparatus of claim 1 having a clearance between the first blade and the body to admit and permit reciprocation of the reciprocating element.

14. An apparatus for pulling plants comprising,
a) a body having a first end and a second end;
b) a first blade attached to a first end of the body;
c) a rotating blade attached to the first end of the body, the rotating blade being rotatable between open and closed positions relative to the first blade and biased towards the open position; and,
d) a reciprocating element movable between lower and upper positions relative to the body, the reciprocating element being closer to the first end of the body in the lower position, the reciprocating element biased towards the upper position,
wherein
e) the reciprocating element, when in the upper position, prevents the rotating blade from moving from the closed position to the open position;
f) the reciprocating element, when in the lower position, prevents the rotating blade from moving to the closed position; and,
g) the rotating blade, when in the open position, prevents the reciprocating element from moving from the lower position to the upper position.

15. The apparatus of claim 14 having a step for using a foot to push the weed puller into the ground.

16. The apparatus of claim 14 wherein the second blade is biased towards an open position.

17. The apparatus of claim 14 wherein the second blade is angled downwards towards the first blade.

18. The apparatus of claim 14 wherein the reciprocating element has a first abutment for bearing against a proximal end of the second blade while in a first position to prevent opening of the second blade.

19. The apparatus of claim 14 having a reciprocating element having a second abutment for bearing against a notch in the second blade while the second blade is in an open position to prevent upward movement of the reciprocating element.

20. The apparatus of claim 14 having a reciprocating element having a third abutment for pushing or keeping the second blade in an open position.

21. The apparatus of claim 14 having a reciprocating element having a fourth abutment for pushing a pulled plant away from the body.

22. The apparatus of claim 14 having a reciprocating element having a fifth abutment for preventing movement of the reciprocating element upwards past an upper position.

23. The apparatus of claim 14 having a spring or other resilient means to bias a reciprocating element towards an upper position.

24. The apparatus of claim 14 having a notch or abutment on the second blade preventing the reciprocating element from moving towards an upper position while the second blade in an open position.

25. The apparatus of claim 14 having an interference fit between the reciprocating element and the second blade preventing movement of the reciprocating element to an upper position while the second blade is in an open position.
